(19) United States
(12) Patent Application Publication
(10) Pub. No.: US 2023/0081949 A1
(43) Pub. Date: Mar. 16, 2023

(54) ASPHALT SAW BLADE

(71) Applicant: Weldco Fabrication and Design, LLC, Vernal, UT (US)

(72) Inventors: Rhadd Vernon Willer, Grand Junction, CO (US); Jacob Robert Willer, Vernal, UT (US)

(21) Appl. No.: 17/477,306

(22) Filed: Sep. 16, 2021

(51) Int. Cl. E01C 23/09; B23D 61/02

(52) U.S. Cl. CPC E01C 23/0933; B23D 61/025

(57) ABSTRACT

A unique design is provided that increases the strength and extends the life of an asphalt saw blade. The asphalt saw blade may include a main body, outer plates and cutter assemblies that are secured to the main body and outer plates. The cutter assemblies can include a front cutter component and a rear cutter component that interlock. The front cutter component may include cutting elements and a plate that reinforces the cutting elements while also shielding the front cutter component's main body from wear. The rear cutter component may also include cutting elements.

### CROSS-REFERENCE TO RELATED APPLICATIONS

This application is related to U.S. patent application Ser. No. 16/983,210 which was filed on Aug. 3, 2020 and is titled Asphalt Saw Blade.

### BACKGROUND

It is oftentimes necessary to cut asphalt such as to repair potholes or other road damage, to install utilities, to run fiber optic cables, etc. Because asphalt is softer than other paving materials such as concrete, a specialized saw blade is typically used. Such “asphalt saw blades” typically use a strong metal to bond small diamonds to the saw blade, or more particularly, along the sides and radial edge of teeth that extend around the circumference of the saw blade's main body.

As the saw blade passes through asphalt, the diamonds grind away the asphalt. The strong metal that bonds the diamonds to the saw blade allows the diamonds to chip rather than breaking off. This ensures that a fresh cutting edge will exist on the diamonds for a prolonged period. Eventually, the diamonds will wear completely down or break off at which point the asphalt saw blade will need to be replaced.

### BRIEF SUMMARY

The present invention extends to asphalt saw blades. More particularly, embodiments of the present invention encompass a unique design of an asphalt saw blade that can increase the strength and extend the life of the asphalt saw blade. In some embodiments, an asphalt saw blade may include a main body, outer plates and cutters that are secured to the main body and outer plates via a notched interface. The cutters can include cutting elements and a plate that reinforces the cutting elements while also shielding the cutter's main body from wear.

In some embodiments, an asphalt saw blade may include a main body, outer plates and cutter assemblies that are secured to the main body and outer plates. The cutter assemblies can include a front cutter component and a rear cutter component that interlock. The front cutter component may include cutting elements and a plate that reinforces the cutting elements while also shielding the front cutter component's main body from wear. The rear cutter component may also include cutting elements.

In a first example embodiment, the present invention may be implemented as an asphalt saw blade that includes a main body, outer plates and cutter assemblies. The main body may have a plurality of teeth. The outer plates may be coupled to opposing sides of the main body and may have teeth that align with the teeth of the main body. The cutting assemblies may be coupled to the teeth of the main body and to the teeth of the outer plates.

In the first example embodiment, each cutter assembly may comprise a front cutter component and a rear cutter component. Each front cutter component may comprise a cutter main body having a front portion and a rear portion. Each front cutter component may include a plate that is coupled to a front surface of the front portion of the front cutter component. Each front cutter component may include one or more cutting elements that are coupled to the front surface of the front portion of the cutter main body. The plate may include a notch within which the one or more cutting elements are positioned. Each front cutter component may include a channel that is formed in a rear surface of the front portion of the front cutter component.

In the first example embodiment, each rear cutter component may include an inner portion and an outer portion. The outer portion may have a front surface from which an interlocking member extends. The interlocking member may be configured to insert into the channel when the rear cutter component is joined to the front cutter component. Each rear cutter component may include one or more cutting elements on an outer surface of the outer portion.

In the first example embodiment, the front cutter component may be coupled to the rear cutter component by one or more first welds and the cutter assembly may be coupled to the teeth of the main body and to the teeth of the outer plates by one or more second welds. The front cutter component and the rear cutter component may have beveled edges.

In a second example embodiment, the present invention may be implemented as an asphalt saw blade that includes a main body having a plurality of teeth and a plurality of cutter assemblies. Each cutter assembly may be coupled to a particular tooth of the plurality of teeth on the main body. Each cutter assembly may comprise a front cutter component and a rear cutter component.

In the second example embodiment, each front cutter component may have a cutter main body, a plate secured to a front surface of the cutter main body and one or more cutting elements. Each rear cutter component may include one or more cutting elements. The front cutter component and the rear cutter component may interlock. The front cutter component may include a channel and the rear cutter component may include an interlocking member that inserts into the channel. The front cutter component and the rear cutter component may have L shapes.

In the second example embodiment, the asphalt saw blade may also include outer plates that are coupled to opposing sides of the main body. The outer plates may have teeth that align with the teeth of the main body.

In a third example embodiment, the present invention may be implemented as an asphalt saw blade that includes a main body, outer plates and cutter assemblies. The main body has an inner body and a plurality of teeth that extend from a radial edge of the inner body. The outer plates have an inner body and a plurality of teeth that extend from a radial edge of the inner body of the outer plates. The outer plates are coupled to opposing sides of the main body. The teeth of the outer plates align with the teeth of the main body. The cutter assemblies are coupled to the teeth of the main body. Each cutter assembly comprises a front cutter component and a rear cutter component.

In the third example embodiment, the front cutter component may include one or more cutting elements on a front surface and the rear cutter component may include one or more cutting elements on an outer surface.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIGS. 1A and 1B provide a perspective side view and a side view respectively of an asphalt saw blade that is configured in accordance with embodiments of the present invention;

FIG. 2A provides a side view of the asphalt saw blade of FIGS. 1A and 1B without the cutters;

FIG. 2B provides a detailed view of a portion of FIG. 2A showing various teeth of the asphalt saw blade;

FIG. 3 provides an isolated side view of the main body of the asphalt saw blade of FIGS. 1A and 1B;

FIG. 4 provides an isolated side view of an outer plate of the asphalt saw blade of FIGS. 1A and 1B;

FIG. 5A provides an isolated perspective side view of a cutter of the asphalt saw blade of FIGS. 1A and 1B;

FIG. 5B provides an exploded view of the cutter of FIG. 5A;

FIG. 5C provides a rear view of the cutter of FIG. 5A;

FIG. 5D provides a front view of the cutter of FIG. 5A;

FIG. 5E provides a side view of the cutter of FIG. 5A;

FIG. 5F provides a top view of the cutter of FIG. 5A;

FIG. 6 provides a detailed view of a portion of FIG. 1B showing how a cutter is positioned relative to the teeth of the main body and outer plates;

FIG. 7 provides a perspective side of another asphalt saw blade that is configured in accordance with embodiments of the present invention;

FIG. 8 provides a detailed view of a portion of the asphalt saw blade of FIG. 7; and

FIGS. 9A-9C provide various views of a cutter assembly of the asphalt assembly of FIG. 7.

### DETAILED DESCRIPTION

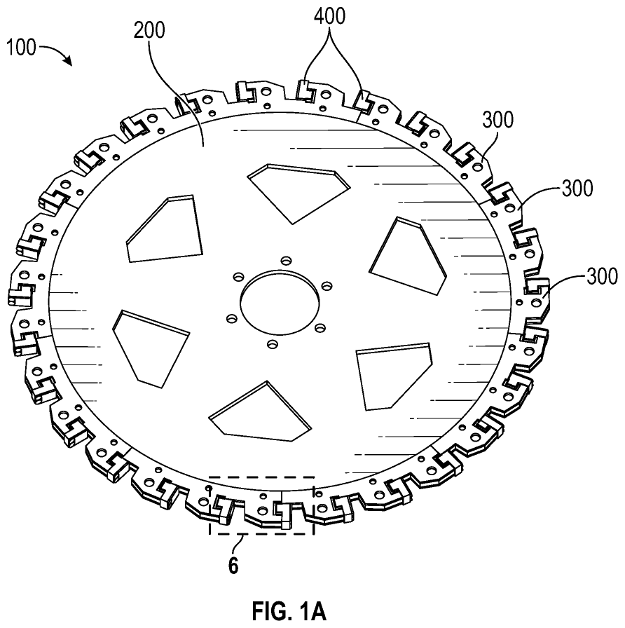

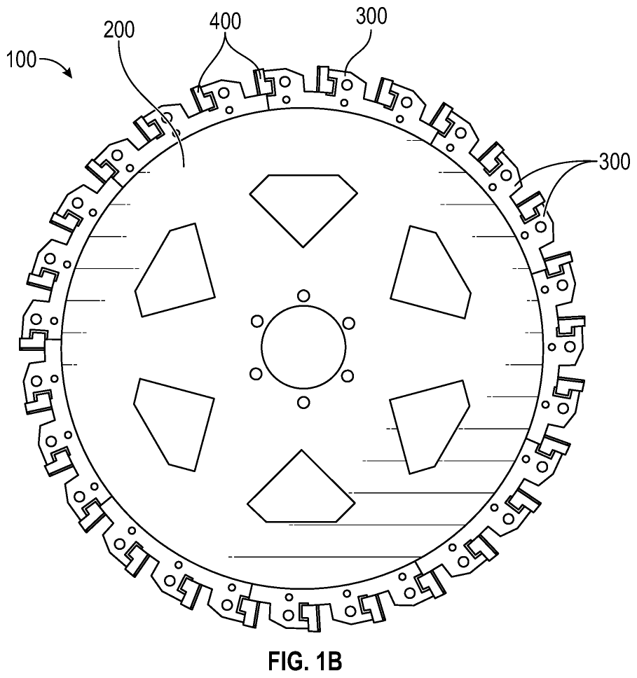

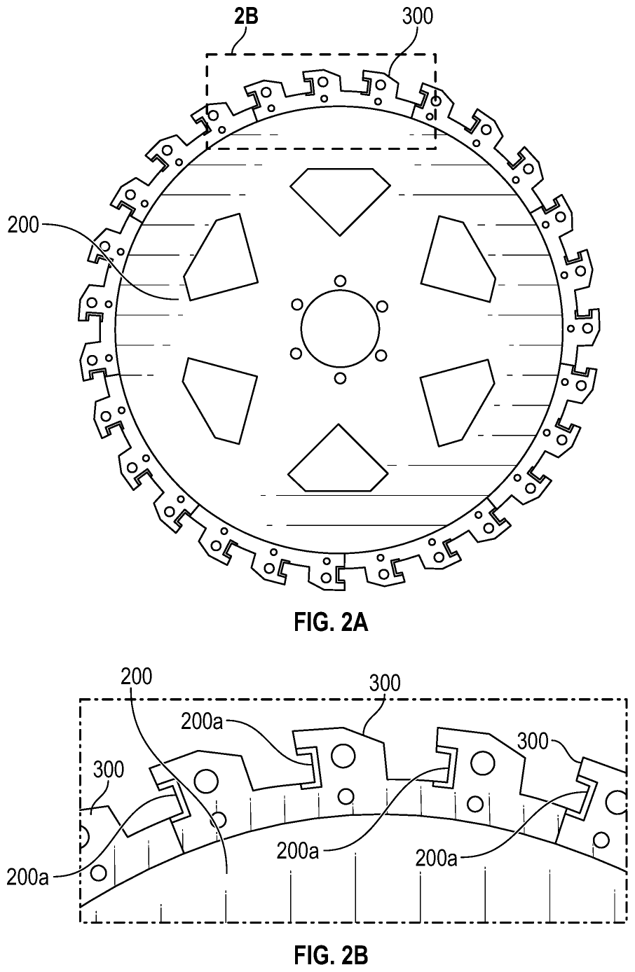

FIGS. 1A and 1B provide a perspective side view and a side view respectively of an asphalt saw blade 100 that is configured in accordance with embodiments of the present invention. Asphalt saw blade 100 includes a main body 200, a number of outer plates 300 and a number of cutters 400. FIGS. 3, 4 and 5A illustrate main body 200, an outer plate 300 and a cutter 400 in isolation, while FIGS. 2A and 2B illustrate main body 200 and outer plates 300 without cutters 400.

With primary reference to FIG. 3, main body 200 has a circular shaped inner body 205 and includes a number of teeth 210 that extend from a radial edge 205a of inner body 205. Each tooth 210 includes a leading edge 210a and a trailing edge 210b. In this context, the term “leading” represents that leading edge 210a is the edge that is the leading (or front) edge when asphalt saw blade 100 is used. For example, with reference to the orientation shown in FIG. 1B, asphalt saw blade 100 would rotate in a counterclockwise direction. Each of teeth 210 includes a notch 211 formed in leading edge 210a. Notch 211 is positioned adjacent to radial edge 205a. In other words, radial edge 205a defines the axially inward edge of notch 211.

Although FIG. 3 shows that radial edge 205a forms a circle, in some embodiments, each portion of radial edge 205a need not extend along the same circle. For example, in some embodiments, one portion of radial edge 205a may be axially offset relative to another portion of radial edge 205a. Similarly, in some embodiments, a portion of radial edge 205a may form a straight line (as opposed to a curved line that matches the circumference of a circle), may be angled relative to a circumference of a circle or may form some other shape that does not match a generally circular shape. In short, embodiments of the present invention should not be limited to any particular configuration of radial edge 205a, and therefore, radial edge 205a may be construed as the portion of inner body 205 that extends between adjacent teeth 210.

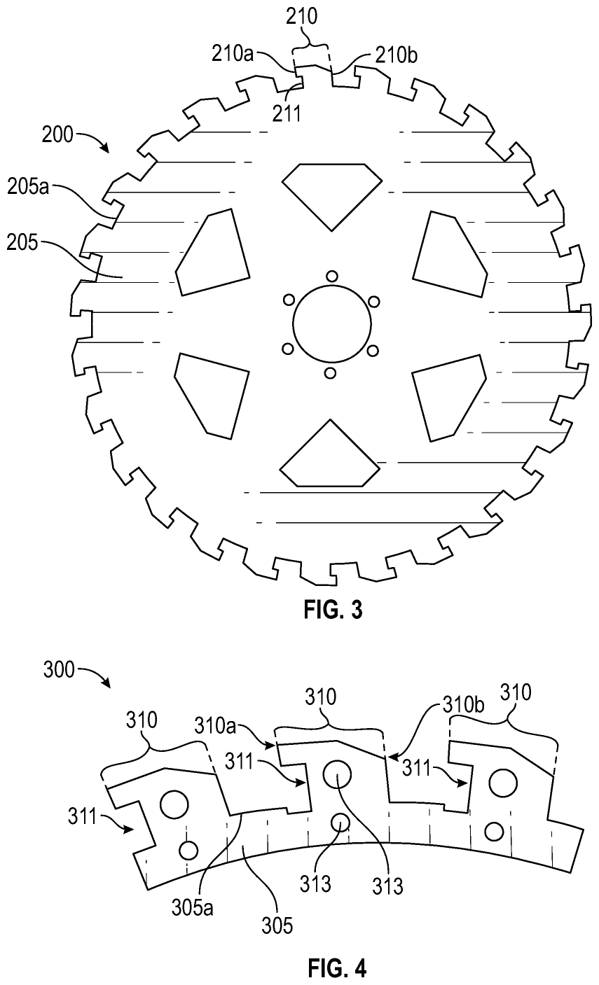

Outer plate 400, which may be formed of steel alloy, may have a shape that generally matches the shape of a section of the outer portion of main body 200. A pair of outer plates 400 may be positioned on either side of a section of main body 200 to provide reinforcement to the section (among other things as described below). With primary reference to FIG. 4, each outer plate 400 includes an inner body 305 forming a radial edge 305a that aligns with radial edge 205a and a number of teeth 310 that align with teeth 210. More particularly, each tooth 310 includes a leading edge 310a and a trailing edge 310b that match the shape and size of leading edge 210a and trailing edge 210b respectively of tooth 210. As best seen in FIG. 2B, each tooth 310 also includes a notch 311 that generally matches, but is larger than, the corresponding notch 211 such that an exposed region 200a is created on both sides of main body 200 when outer plates 400 are coupled to main body 200.

In the depicted embodiment, exposed region 200a has a general C-shape, or in other words, notch 311 exposes the portion of main body 200 that surrounds the generally C-shaped notch 211. Therefore, in the depicted embodiment, exposed region 200a encompasses a portion of main body 200 that extends axially outwardly from an axially inward facing edge of notch 211, a portion of main body that extends rearwardly from a frontward facing edge of notch 211 and a portion of main body that extends axially inwardly from radial edge 205a. Although notch 311 has the same shape as notch 211 in the depicted embodiments, in other embodiments, notch 211 and notch 311 can have different shapes.

In the depicted embodiments, each outer plate 300 includes three teeth 310. However, an outer plate 300 could include any other number of teeth 310 and each outer plate 300 need not include the same number of teeth 310. Also, in some embodiments, a single outer plate 300 could be used on each side of main body 200 (i.e., each outer plate 300 could have the same number of teeth as main body 200). However, to facilitate the manufacturing process, such as to minimize the amount of material required to form outer plates 300 while ensuring that each outer plate 300 is the same, it may be preferable to configure outer plates 300 to each include a number of teeth 310 that divides equally into the total number of teeth 210. For example, in the depicted embodiment, main body has 27 teeth 210, and therefore 9 outer plates 300 are used, each of which includes 3 teeth 310 (27/9=3). Accordingly, the number of outer plates 300 and the number of teeth 310 that each outer plate 300 includes can depend on the number of teeth 210 that main body 200 includes.

In addition to including notch 311 that creates exposed region 200a around notch 211, each outer plate 300 may also include a number of openings 313 spaced along the outer plate. Openings 313 can expose a portion of main body 200 and can function to facilitate the attachment of outer plate 300 to main body 200 (e.g., via welding).

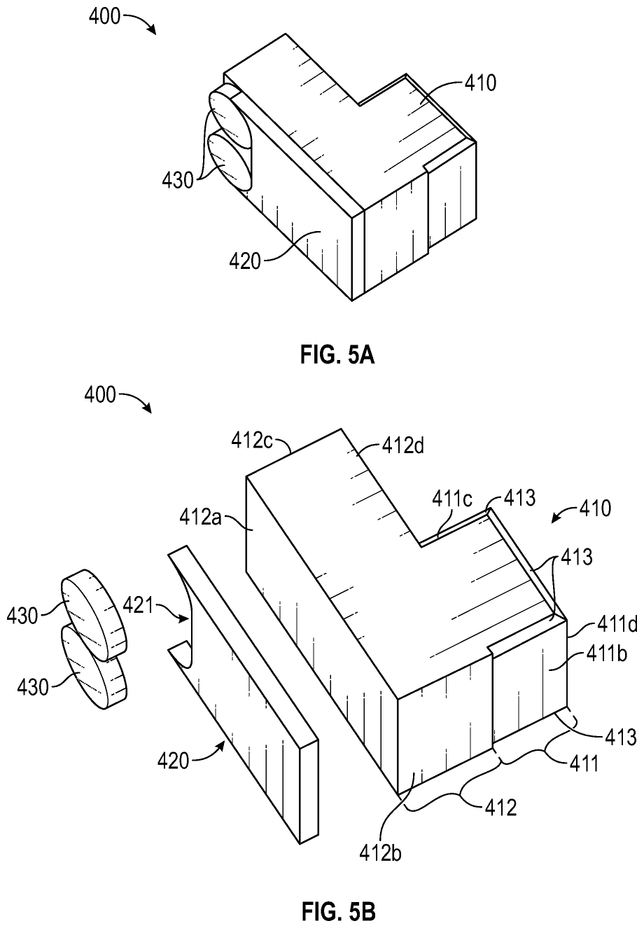

FIGS. 5A-5F each provide a view of a cutter 400 that is configured in accordance with embodiments of the present invention. As best seen in the exploded view in FIG. 5B, cutter 400 includes a cutter main body 410, a plate 420 and one or more cutting elements 430. Cutter main body 410, which may be formed of a steel alloy, has a general L-shape formed by a rear portion 411 and a front portion 412. Rear portion 411 includes an inner surface 411b (which references that the surface faces axially inward), an outer surface 411c (which references that the surface faces axially outward) and a rear surface 411d (which references that the surface faces towards trailing edge 210b/310b). Front portion 412 includes a front surface 412a, an inner surface 412b, an outer surface 412c and a rear surface 412d.

Plate 420 is configured to be coupled to front surface 412a to thereby secure plate 420 to cutter main body 410. Plate 420, which may be formed of tungsten or another hard metal, primarily functions to shield cutter main body 410, including to prevent the width of cutter main body 410 from being worn away. A notch 421 is formed in the outer edge of plate 420 and is shaped and sized to receive cutting element(s) 430. For example, in the depicted embodiment, notch 421 has a generally rectangular shape but has rounded corners to match the circular shape of the two cutting elements 430 that are positioned therein. Accordingly, with cutting elements 430 positioned side-by-side, the rounded edges of cutting elements 430 will be positioned against the rounded corners of notch 421. The walls of notch 421 can therefore reinforce and retain cutting elements 430 as asphalt saw blade 100 is used. It is noted, however, that cutting elements 430 of different shapes and/or sizes and/or a different number of cutting elements 430 could be used in embodiments of the present invention. In such cases, the shape and/or size of notch 421 could be adapted to ensure that notch 421 will receive and reinforce the cutting element(s).

Plate 420 may have a width that generally matches the width of front portion 412 of cutter main body 410 and a height that is less than the height of front portion 412 of cutter main body 410. As best seen in FIGS. 5C and 5D, the height of plate 420 and/or the positioning of notch 421 can cause cutting elements 430 to extend outwardly beyond outer surface 412c of front portion 412. Accordingly, in some embodiments including the depicted embodiment, plate 420 substantially covers front surface 412a except for the portions of front surface 412a over which cutting elements 430 are positioned. In some embodiments, the combined width of cutting elements 430 can substantially match the width of front surface 412a as shown in FIG. 5D. Both plate 420 and cutting element(s) 430 can be coupled to front surface 412a in any suitable manner (e.g., via welding).

Cutting elements 430, which may be formed of polycrystalline diamond (PCD), function to cut through asphalt. By employing two circular shaped cutting elements 430, the combined length of the cutting edge is maximized. However, embodiments of the present invention should not be limited to any particular number or shape of cutting elements 430.

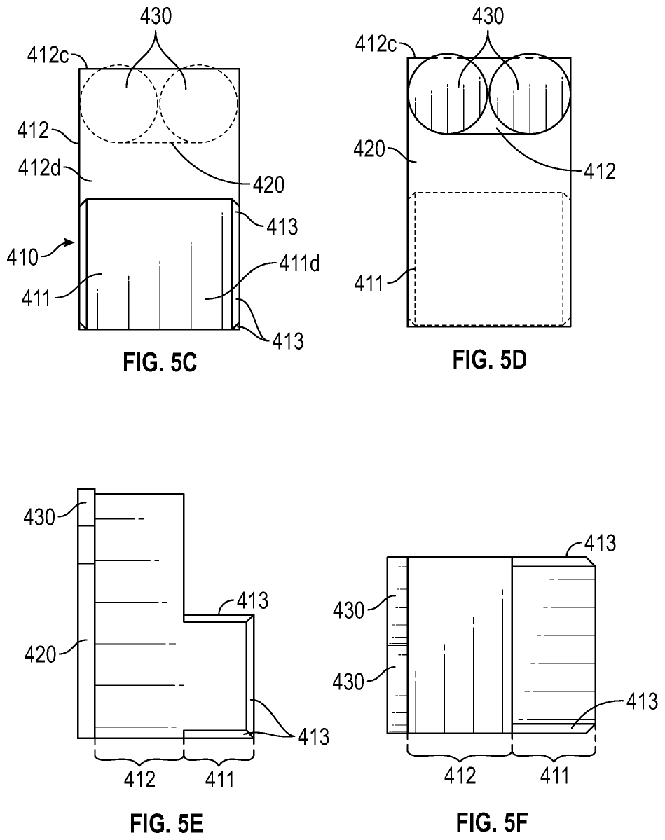

As is best shown in FIG. 6, which is a detailed view of a portion of FIG. 1A, with rear surface 412d of front portion 412 positioned against leading edge 210a/310a and inner surface 412b positioned against radial edge 205a/305a, rear portion 411 of cutter main body 410 will insert into and be positioned within notches 211 and 311. Accordingly, exposed portion 200a on both sides of main body 200 will surround rear portion 411. With rear portion 411 in this position, cutter 400 can be secured directly to main body 200. In particular, by configuring outer plates 300 to create exposed portion 200a, outer plates 300 can reinforce main body 200, and particularly teeth 210, while retaining the ability to weld cutter 400 directly to main body 200. Rear portion 411 may also have beveled edges 413 to enhance the weld penetration (i.e., to allow the weld to wrap around the sides of rear portion 411.

Notches 211 and 311 also provide greater surface area for the connection between cutter 400 and main body 200/outer plates 300. In other words, once welded or otherwise coupled, rear portion 411 will be locked within notches 211 and 311 thereby making it much less likely that cutter 400 will break away from asphalt saw blade 100.

In summary, an asphalt saw blade configured in accordance with embodiments of the present invention may provide a notched interface for coupling the cutters to the main body of the asphalt saw blade and may reinforce this notched interface with outer plates. The cutter itself can be configured with cutting elements and a plate that reinforces the cutting elements and protects the cutter's main body from wear. Such configurations can greatly enhance the life of an asphalt saw blade.

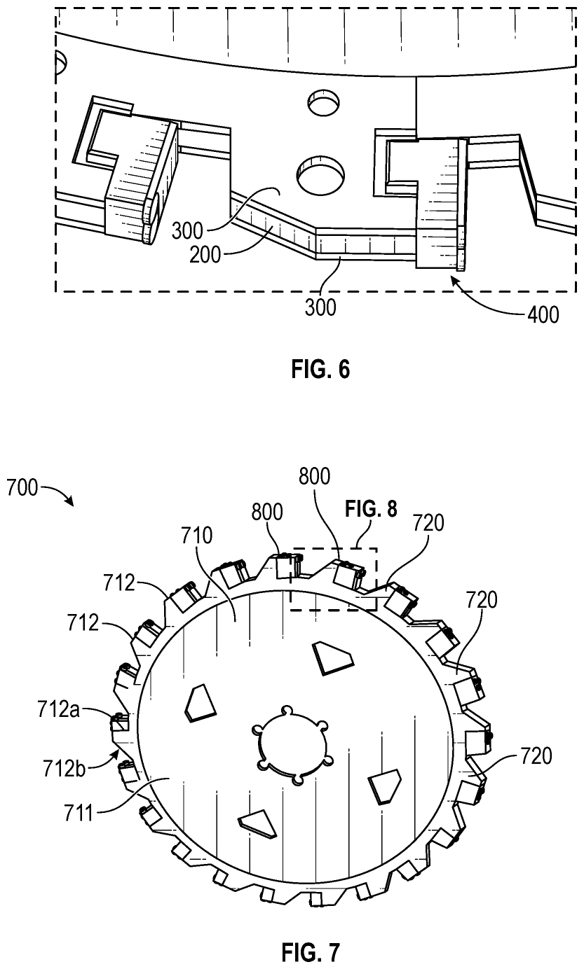

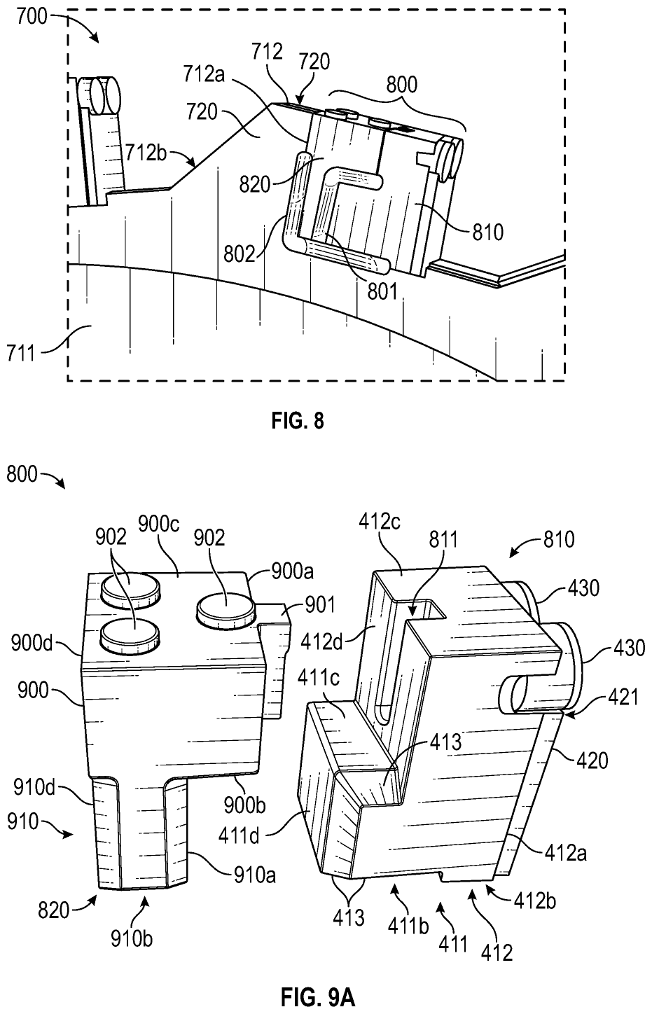

FIGS. 7 and 8 provide an example of another asphalt saw blade 700 that is configured in accordance with one or more embodiments of the present invention. Asphalt saw blade 700 is similar to asphalt saw blade 100 but employs a cutter assembly 800 in place of cutter 400.

Asphalt saw blade 700 includes a main body 710 and outer plates 720 that are substantially the same as main body 200 and outer plates 300 described above. For example, main body 710 includes a circular shaped inner body 711 and a number of teeth 712 that extend from the radial edge of inner body 711. Each tooth 712 includes a leading edge 712a and a trailing edge 712b. Unlike leading edge 210a of teeth 210, leading edge 712a of teeth 712 does not include a notch but may be substantially flat to accommodate cutter assembly 800. Each outer plate 720 may have a shape that corresponds to teeth 712 in a similar manner as described above for outer plate 300 and teeth 210.

As shown in the closeup view in FIG. 8, cutter assembly 800 includes a front cutter component 810 and a rear cutter component 820 that may be interlocked and secured together via welds 801. Cutter assembly 800 may be secured to main body 710 and outer plates 720 via welds 802.

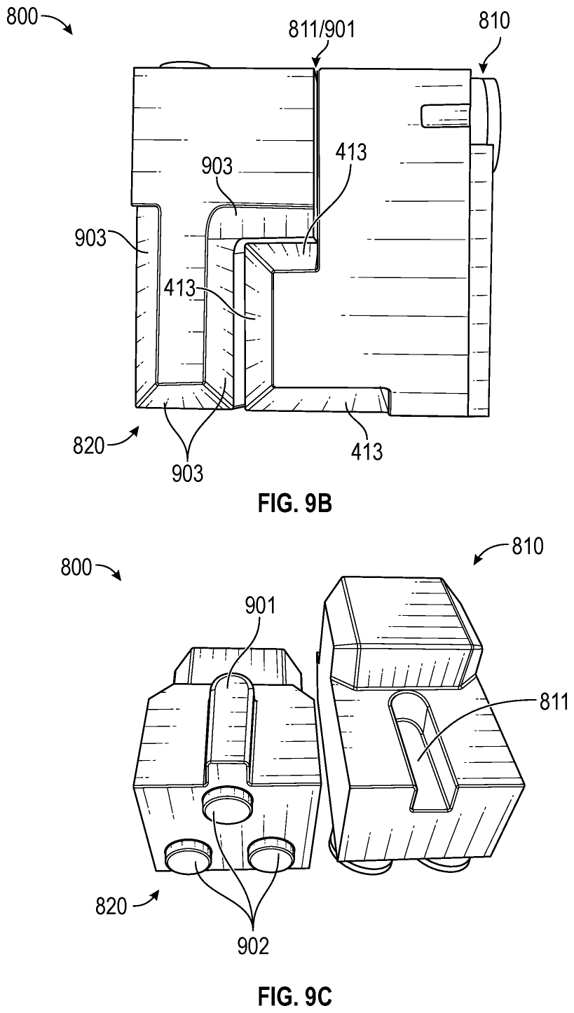

FIGS. 9A-9C provide views of cutter assembly 800 in isolation. Front cutter component 810 can be substantially the same as cutter 400 except that a channel 811 is formed in rear surface 412d. Rear cutter component 820 can have a generally inverted L shape that corresponds to the shape of the rear-facing surfaces of front cutter component 810. In other words, front and rear cutter components 810 and 820 can be positioned together to cause cutter assembly 800 to have a generally rectangular shape. In particular, rear cutter component 820 may have an outer portion 900 and an inner portion 910 (where “outer” and “inner” are relative to the rotational axis of asphalt saw blade 700). An interlocking member 901 may extend frontwardly from a front surface 900a of outer portion 900 and can be sized and shaped to fit inside channel 811 in front cutter component 810 when front surface 900a abuts rear surface 412d. An inner surface 900b of outer portion 900 may abut outer surface 411c and a front surface 910a of inner portion 910 may also abut rear surface 411d when interlocking member 901 is inside channel 811. When positioned within channel 811, interlocking member 901 can inhibit side-to-side movement between front and rear cutter components 810 and 820 and can inhibit outward movement of front cutter component 810 relative to rear cutter component 820. An inner surface 910b of inner portion 910 may generally align with inner surfaces 411b and 412b, all of which may abut the radial edge of main body 711 when cutter assembly 800 is secured to main body 711. Also, rear surface 900d/910d can be configured to abut leading edge 712a.

Rear cutter component 820 may include beveled edges 903 to increase the weld penetration of welds 801 and 802. For example, beveled edges 903 may extend along inner surface 900b, front surface 910a, inner surface 910b and rear surface 910d.

In addition to cutting elements 430 on front cutter component 810, one or more cutting elements 902 may also be positioned on outer surface 900c of rear cutter component 820. For example, a triangular arrangement of three cutting elements 902 may be employed where one cutting element 902 is positioned towards front surface 900a and centered on outer surface 900c and two cutting elements 902 are positioned towards rear surface 900d and spaced apart. However, other arrangements of cutting elements 902 could be employed.

With the design of cutter assembly 800, front cutter component 810 can be secured to rear cutter component 820 via welds 801 prior to securing cutter assembly 800 to main body 710 via welds 802. Also, the design of cutter assembly 800 creates a greater distance between weld 802 and much of front cutter component 810 and particularly plate 420 and cutting elements 430, such that heat generated by weld 802 may have a reduced impact on front cutter component 810. For example, the design enables a more substantial weld 802 to be performed without the risk of compromising the securement of plate 420 and cutting elements 430 to front cutter component 810.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. An asphalt saw blade comprising:
a main body having a plurality of teeth;
outer plates that are coupled to opposing sides of the main body, the outer plates having teeth that align with the teeth of the main body; and
cutter assemblies that are coupled to the teeth of the main body and to the teeth of the outer plates.

2. The asphalt saw blade of claim 1, wherein each cutter assembly comprises a front cutter component and a rear cutter component.

3. The asphalt saw blade of claim 1, wherein each front cutter component comprises a cutter main body having a front portion and a rear portion.

4. The asphalt saw blade of claim 3, wherein each front cutter component includes a plate that is coupled to a front surface of the front portion of the front cutter component.

5. The asphalt saw blade of claim 4, wherein each front cutter component includes one or more cutting elements that are coupled to the front surface of the front portion of the cutter main body.

6. The asphalt saw blade of claim 5, wherein the plate includes a notch within which the one or more cutting elements are positioned.

7. The asphalt saw blade of claim 3, wherein each front cutter component includes a channel that is formed in a rear surface of the front portion of the front cutter component.

8. The asphalt saw blade of claim 7, wherein each rear cutter component includes an inner portion and an outer portion, the outer portion having a front surface from which an interlocking member extends, the interlocking member being configured to insert into the channel when the rear cutter component is joined to the front cutter component.

9. The asphalt saw blade of claim 8, wherein each rear cutter component includes one or more cutting elements on an outer surface of the outer portion.

10. The asphalt saw blade of claim 2, wherein the front cutter component is coupled to the rear cutter component by one or more first welds and the cutter assembly is coupled to the teeth of the main body and to the teeth of the outer plates by one or more second welds.

11. The asphalt saw blade of claim 10, wherein the front cutter component and the rear cutter component have beveled edges.

12. An asphalt saw blade comprising:
a main body having a plurality of teeth; and
a plurality of cutter assemblies, each cutter assembly being coupled to a particular tooth of the plurality of teeth on the main body;
wherein each cutter assembly comprises a front cutter component and a rear cutter component.

13. The asphalt saw blade of claim 12, wherein each front cutter component has a cutter main body, a plate secured to a front surface of the cutter main body and one or more cutting elements.

14. The asphalt saw blade of claim 13, wherein each rear cutter component includes one or more cutting elements.

15. The asphalt saw blade of claim 14, wherein the front cutter component and the rear cutter component interlock.

16. The asphalt saw blade of claim 15, wherein the front cutter component includes a channel and the rear cutter component includes an interlocking member that inserts into the channel.

17. The asphalt saw blade of claim 16, wherein the front cutter component and the rear cutter component have L shapes.

18. The asphalt saw blade of claim 10, further comprising:
outer plates that are coupled to opposing sides of the main body, the outer plates having teeth that align with the teeth of the main body.

19. An asphalt saw blade comprising:
a main body having an inner body and a plurality of teeth that extend from a radial edge of the inner body;
outer plates having an inner body and a plurality of teeth that extend from a radial edge of the inner body of the outer plates, the outer plates being coupled to opposing sides of the main body, the teeth of the outer plates aligning with the teeth of the main body; and
cutter assemblies that are coupled to the teeth of the main body, each cutter assembly comprising a front cutter component and a rear cutter component.

20. The asphalt saw blade of claim 19, wherein the front cutter component includes one or more cutting elements on a front surface and the rear cutter component includes one or more cutting elements on an outer surface.
